(19) United States
(12) Patent Application Publication
(10) Pub. No.: US 2023/0255250 A1
(43) Pub. Date: Aug. 17, 2023

(54) COMPOSITION FOR NUTRITIONAL SUPPLEMENTATION THAT PREVENTS DAMAGE CAUSED BY OXIDATIVE STRESS, HAVING AS PRINCIPLES XANTHOPHYLLS FROM MICROALGAE

(71) Applicant: JOSE JAIME MAUSSAN FLOTA, Mexico City (MX)

(72) Inventors: Jose Jaime MAUSSAN FLOTA, Mexico City (MX); Ericka Patricia FLORES BERRIOS, Mexico City (MX); Gabriel LARA HERNANDEZ, Mexico City (MX); Jose De Jesús ZALCE BENITEZ, Mexico City (MX)

(21) Appl. No.: 18/107,812

(22) Filed: Feb. 9, 2023

(30) Foreign Application Priority Data
Feb. 9, 2022 (MX) MX/A/2022/001728

(51) Int. Cl. A23L 33/105; A23L 29/10; A23L 29/30

(52) U.S. Cl. CPC A23L 33/105; A23L 29/10; A23L 29/35

(57) ABSTRACT

The disclosure describes a composition for nutritional supplementation that prevents damage caused by oxidative stress, having as its principle components xanthophyll compounds of microalgae, and methods of use and manufacture of the compositions. The compositions may be effective for multiple health-related conditions, as well as the promotion of gastrointestinal health and wellness. The disclosure also describes a functional suspension composition containing, among other components, xanthophylls, such as astaxanthin and fucoxanthin, in a stable oil-in-water suspension. The functional suspension composition optionally also includes additional functional and/or nutraceutical ingredients effective for one or more health benefits. Methods of application for health maintenance or the treatment of diseases with the compositions are also described.

### CROSS REFERENCE TO RELATED APPLICATIONS

The present application claims priority of Mexican patent application number MX/a/2022001728 filed Feb. 9, 2022.

### FIELD OF THE INVENTION

The present specification describes the process to produce an antioxidant suspension, particularly the invention describes a supplement that incorporates antioxidants, including components of the xanthophyll family extracted from seaweed that act synergistically to obtain a high capacity for absorbing free radicals. The composition comprises water-soluble ingredients and fat-soluble components, as well as short-chain oligosaccharides that improve the emulsification of the components and may contain flavor and odor elements to improve the sensory profile of the product.

### BACKGROUND OF THE INVENTION

An antioxidant is defined as a natural or synthetic substance that prevents or eliminates oxidation; in humans, these substances delay or prevent oxidation produced by free radicals, which are the cause of cell damage and aging.

Antioxidants are present in the human body and in food, however their intake is generally insufficient to contain the cell damage caused by reactive oxygen species (ROS) that are produced during oxidation. Reactive oxygen species attack macromolecules such as lipids, proteins and DNA (deoxyribonucleic acid) inducing cell damage and what is called oxidative stress. Antioxidants, including carotenoid pigments, are natural compounds present in various structures of plants, animals, algae, fungi and bacteria. These compounds are tetraterpenes made up of isoprenoid units with a substituted and unsaturated cyclohexane ring at each end.

The property of absorbing light is derived from the presence of conjugated double bonds that absorb visible light in colors from yellow to red.

Carotenoids have been shown to inactivate singlet oxygen, hydroxyl, peroxides, and other antioxidants by transferring energy from high levels of excitation to a carotenoid triplet. There are two types of carotenoids, carotenoids that do not contain oxygen in their terminal rings and xanthophylls that contain oxygen in their terminal rings such as lutein and astaxanthin. Astaxanthin is a stereoisomer of lutein present in microalgae (Hematococcus pluvialis), in yeast (Phaffia rhodozyma), crustaceans (shrimp and lanostino), fish (salmon) and some birds.

Fucoxanthin is also a carotenoid present in brown marine algae belonging to the Phaeophyceae group, its structure is formed by an allenic bond and carbonyl, hydroxyl and carboxyl functional groups that may be responsible for diverse biological properties of this antioxidant carotenoid.

Currently, to replace deficiencies in antioxidant intake in the diet, products are sought that allow stopping damage caused by oxidative stress, that is, aging. For example, consumers include supplements in the form of capsules, powders, suspensions, or beverages containing increased levels of biologically active compounds into their diet to promote or enhance their physical or emotional health. More often, consumers are looking for functional formulas made from natural ingredients to manage, mitigate, or otherwise control symptoms of minor or major disease states (e.g., aging, diabetes, hypertension, cancer, etc.), mitigate transient conditions (for example, headaches, exhaustion, anxiety, intestinal bloating, insomnia, etc.), or prevent unhealthy conditions and maintain a healthy state. A beverage that integrates the necessary components to prevent oxidative stress in a balanced and adequate way and mitigates the cellular, metabolic and physiological damage caused therefrom will provide multiple benefits to the population.

The health status of an individual can depend on multiple variables and be a consequence of the convergence of several causes; for example, oxidative stress affects cell integrity and progressively alters the immune response; an unbalanced immune system produces numerous diseases ranging from a stomach ailment to cancer. Therefore, the present invention describes a novel preventive and/or therapeutic multifunctional suspension composition that may be effective in treating multiple disease states and conditions, or in maintaining one or more aspects of the individuals' health.

### SUMMARY OF THE INVENTION

The present invention describes a composition for nutritional supplementation that prevents damage caused by oxidative stress, having as principles xanthophylls of microalgae and methods of use and manufacture thereof. The present invention provides a functional suspension composition containing, among others, xanthophylls such as astaxanthin and fucoxanthin. The compositions may be provided in a liquid form that stably holds the astaxanthin and fucoxanthin in stable oil-in-water suspensions. The compositions may be effective for multiple health-related conditions, as well as the promotion of gastrointestinal health and wellness. Astaxanthin and fucoxanthin in the composition provided herein have synergistic activities directed at a number of desired outcomes, for example, health maintenance, disease prevention, and/or disease treatment, including but not limited to inflammation-related diseases or conditions. The functional suspension composition optionally also includes additional functional and/or nutraceutical ingredients effective for one or more health benefits. The disclosed functional suspension composition provides a functional and improved way for individuals to consume a suspension containing the biologically active compounds in a form and concentration to promote significant improvement in reduction of inflammation, oxidative stress, aging, gastrointestinal health, mental health, blood glucose levels, and general well-being. This composition can be used for the treatment and/or maintenance of intestinal health, mental health, immunity, control of blood sugar levels, as well as the effects of aging. The method of application for health maintenance or the treatment of diseases with the composition of the invention described herein is also described.

### DETAILED DESCRIPTION OF THE INVENTION

Whenever antioxidant functional suspension is described in this document, it refers to a liquid functional composition supplemented or fortified with biologically active compounds. Biologically active compounds are preferably included in functional beverage compositions in amounts that provide enhancement benefits (health, nutritional, etc.) to the consumer. The enhancement benefit may be quantitative, qualitative, or subjective, and may promote or maintain health or contribute to disease prevention. Astaxanthin and fucoxanthin are biologically active compounds that can be included in the composition of the invention. Astaxanthin is naturally found in the algae Haematococcus pluvialis and fucoxanthin in the algae Laminaria japonica.

Astaxanthin and fucoxanthin in the suspension of the invention may be included in a water-dispersible form or in oleoresin using sunflower oil or extra virgin avocado oil as oily vehicle.

Lutein, zeaxanthin and beta-carotene are biologically active antioxidants that can be included in the compositions of the invention.

The combination of astaxanthin and fucoxanthin in the compositions of the invention provide synergistic effects and provide benefits against various health ailments. The presence of astaxanthin and fucoxanthin as well as beta-cyclodextrins in the composition of the invention can provide cytotoxic and antitumor properties, body fat-reducing effects, and normalizing effects of lipid metabolism, improvement of the immune system in vivo, preventive activity against hormone-related cancers (prostate and breast) and colon cancer, reduction of hepatic triglycerides accumulation, and promotion of epidermal tissue regeneration, improvement of visual capacity, reductions in allergic skin reactions and stop aging. The antioxidant and anti-inflammatory activities of astaxanthin and fucoxanthin combination may result from oxidative stress inhibition and neutrophil activation. The combination of astaxanthin and fucoxanthin can reduce body weight, lower cholesterol levels, lower insulin levels, improve glucose tolerance, improve peripheral insulin sensitivity, increase carbohydrate oxidative capacity, and inhibit diabetes progression. The combination of astaxanthin and fucoxanthin can improve immune response and treat disorders in the immune system and gastrointestinal tract, as well as promote the development and function of the immune system and prevent metabolic disorders. Furthermore, the combination of astaxanthin and fucoxanthin may be useful against the proliferation and survival of human skin cancer cells among others. The combination of astaxanthin and fucoxanthin can reduce anxiety, help destroy cancer cells, slow tumor growth, help relax tense muscles in people with multiple sclerosis, reduce inflammation, provide pain relief, stimulate appetite, and contribute to greater health benefit from cardiovascular conditions. The combination of astaxanthin and fucoxanthin can be used in the treatment of anxiety and depression and can also provide neuroprotective benefits and improvements in macular degeneration and neuronal degeneration.

In addition to astaxanthin and fucoxanthin, the composition of the invention may optionally include a series of other biologically active compounds. One of these biologically active compounds is 2-Hydroxylpropyl-beta-cyclodextrin (HP-β-CD), cyclodextrins are cyclic oligosaccharides that can incorporate molecules of adequate size as hosts in their apolar cavity, forming inclusion complexes. This complexation process can increase the aqueous solubility of the trapped molecule. Furthermore, air and light stability of labile compounds can be improved upon inclusion in the cyclodextrin cavity. Hydroxypropyl-β-cyclodextrin (HP-β-CD) is obtained by β-cyclodextrin hydroxylation, which substitution can occur in 1-, 2- or 3-position, its solubility is greater than 500 mg/mL in water at room temperature and is not toxic after oral administration in doses less than 500 mg/kg intravenously.

Although hp-β-CD has been suggested as a potential vaccine adjuvant, its immunological properties and mechanism of action have also been studied. HP-β-CD stimulated dendritic cells have been found to exhibit remarkable regulation of molecules such as MHC proteins, and of PD-L1/L2. Furthermore, the production of cytokines, such as TNF-α, IL-6, and IL-10, is increased when treated with HP-β-CD. HP-β-C induces proliferation and activation of T lymphocytes.

Other biologically active compounds that can be included in the composition of the invention are antioxidants. Exemplary antioxidants include neoflavonals, tocopherol, tocotrienol, lipoic acid, melatonin, superoxide dismutase, coenzyme Q10, alpha lipoic acid, vitamin A, chromium biotin, selenium, and ascorbic acid.

Other biologically active compounds that can be included in the compositions of the invention are carotenoids. Exemplary carotenoids include beta-carotene, lycopene, lutein, zeaxathin, astaxanthin, apocarothenal, canthaxanthin, and lutein esters.

Other biologically active compounds that can be included in the compositions of the invention include flavonoids. As used herein, a “flavonoid” or “bioflavonoid” refers to flavonoids, isoflavanoids, and neoflavanoids, subclasses, subgroups, and compounds chemically related thereto, including flavanols, as used and defined in accordance with the IUPAC nomenclature and designation. The flavonoid may be any one or more of esveratrol, quercetin, rutin, catechin, epicatechin, epigallocatechin, epigallocatechin gallate, and proanthocyanidin. In some versions, the concentrations of each of the vitamins and minerals may be at least about 0.1% (w/w), at least about 0.01% (w/w), at least about 0.001% (w/w), at least about 0.0001% (w/w), at least about 0.00001% (w/w), at least about 0.000001% (w/w), at least about 0.0000001% (w/w), or at least about 0.00000001% (w/w) of the final mass of the composition.

The functional antioxidant suspension composition provided herein uses several biologically active components that are not readily solvated in an aqueous medium. Therefore, certain chemical compositions, such as certain emulsifiers and stabilizers, are added to solubilize those biologically active compounds. In some formulations, the functional beverage generally comprises natural emulsifiers and stabilizers or emulsifiers and stabilizers that are extracted, isolated, and/or concentrated from natural sources. In certain embodiments, the functional beverage is comprised of a solvating agent for solvating a non-polar or non-aqueous fluid. In certain other embodiments, the solvating agent is an emulsifier. In certain embodiments, the emulsifier is at least one phospholipid. In specific embodiments one or more of corn or sunflower lecithin, avocado oil and the corresponding serines, ethanol amines, glycerol, and others may be used. According to such embodiments, the formulation may comprise an emulsifier and/or stabilizer between about 0.0001% (v/v) and about 1.0% (v/v), between about 0.0001% (v/v) and about 0.1% (v/v), between about 0.0001% (v/v) and about 0.01% (v/v), between about 0.0001% (v/v) and about 0.001% (v/v) of a final volume of the multifunctional composition of the suspension.

In some versions, water is present in the composition in an amount of at least about 90% w/v, at least about 91% w/v, at least about 92% w/v, at least about 93% w/v, at least about 94% w/v, at least about 95% w/v, at least about 96% w/v, at least about 97% w/v, at least about 98% w/v, at least about 99% w/v, at least about 99.1% w/v, at least about 99.2% w/v, at least about 99.3% w/v, at least about 99.4% w/v, at least about 99.5% w/v, at least about 99.6% w/v, at least about 99.7% w/v, at least about 99.8% w/v, at least about 99.9% w/v.

In some versions, the oil is present in the composition in an amount of at least about 0.0001% w/v, at least about 0.0005% w/v, at least about 0.001% w/v, at least about 0.005% w/v, or about 0.01% w/v. In some versions, avocado oil is present in the composition in an amount up to about 0.05% w/v, up to about 0.1% w/v, up to about 0.5% w/v, up to about 1% w/v, or up to about 5% w/v. The astaxanthin- and fucoxanthin-containing oil may include any oil or mixture of oils containing these antioxidants. In some versions, the astaxanthin-containing oil comprises astaxanthin in an amount of at least about 0.01% w/v, at least about 0.05% w/v, at least about 0.001% w/v, at least about 00005.% w/v, In some versions, the astaxanthin-containing oil comprises punic acid in an amount up to about 1% w/v, up to about 10% w/v, up to about 15% w/v, up to about 20% w/v, up to about 25% w/v, up to about 30% w/v, up to about 35% w/v, up to about 40% w/v, up to about 45% w/v, up to about 45% w/v, up to about 50% w/v. The astaxanthin in the astaxanthin-containing oil may be in any form, including oleoresin, water-dispersible capsule, or powdered oleoresin form.

In some versions, the composition comprises flavors. In some versions the flavor is present in the composition in an amount of at least about 0.0001% w/v, at least about 0.0005% w/v, at least about 0.001% w/v, at least about 0.005% w/v, at least about 0.01% w/v, at least about 0.05% w/v, at least about 0.1% w/v, at least about 0.5% w/v, at least about 1% w/v, at least about 5% w/v, at least about 10% w/v. In some versions, the flavor is present in the composition in an amount of up to about 0.05% w/v, up to about 0.1% w/v, up to about 0.5% w/v, up to about 1% w/v, or up to about 5% w/v. In some versions, the composition further comprises citric acid. In some versions citric acid is present in the composition in an amount of at least about 0.0001% w/v, at least about 0.0005% w/v, at least about 0.001% w/v, at least about 0.005% w/v, at least about 0.01% w/v, at least about 0.05% w/v, at least about 0.1% w/v, at least about 0.5% w/v, at least about 1% w/v, at least about 5% w/v, at least about 10% w/v. In some versions, citric acid is present in the composition in an amount of up to about 0.05% w/v, up to about 0.1% w/v, up to about 0.5% w/v, up to about 1% w/v, or up to about 5% w/v. Citric acid can help stabilize the pH of the composition and can contribute to the flavor profile.

In some versions, the composition is stabilized with sorbic acid. In preferred versions of the compositions of the invention, any oil in the composition, including the astaxanthin-containing oil, the fucoxanthin-containing oil, and any other oil comprised within the composition, are stably suspended within water. “Stably suspended” in this context means that at least 80% w/w of the oil in the composition is suspended in water, rather than floating as a separate phase on the water surface or separating as a separate phase from water for a period of time of at least 1 day. In various versions, at least about 85% w/w of the oil, at least about 87% w/w of the oil, at least about 90% w/w of the oil, at least about 95% w/w of the oil, at least about 96% w/w of the oil, at least about 97% w/w of the oil, at least about 98% w/w of the oil, at least about 99% w/w of the oil, or at least about 99.5% w/w of the oil in the composition is suspended in water, rather than floating as a separate phase on the surface. % w/w of the oil in the composition is suspended in water, rather than floating as a separate phase on the surface of the water or separating as a separate phase from the water for a period of time of at least 1 day, at least about 30 days, at least about 90 days, or at least about a year. These parameters can be measured by collecting the oil floating on the surface of the water (or otherwise separated from the water), determining the mass of oil collected, and calculating the ratio of the oil collected mass as a percentage of the total oil mass added to the composition during its production.

Methods of manufacturing the composition of the invention are also provided herein. Some methods include one or more of the following steps: providing a water sub-volume, where the sub-volume is less than a final composition volume; adding HP-β-CD to water sub-volume to generate a mixture of HP-β-CD and water; incubation of the HP-β-CD-water mixture; mixing an astaxanthin-containing oil or powder and a fucoxanthin-containing oil or powder to generate an oil mixture; adding the oil mixture to the HP-β-CD mixture and water to generate an oil-in-water emulsion; adding water to the oil-in-water emulsion in an amount to increase the volume of the oil-in-water emulsion to the final composition volume, thereby generating a full-volume oil-in-water emulsion. In some versions, the water sub-volume has a volume of at least about 1% v/v, at least about 5% v/v, at least about 10% v/v, at least about 15% v/v, at least about 20% v/v, at least about 25% v/v, at least about 30% v/v, at least about 35% v/v, at least about 40% v/v, at least about 45% v/v, at least about 50% v/v, at least about 55% v/v, at least about 60% v/v, at least about 75% v/v, at least about 80% v/v, at least about 90% v/v, or at least about 95% v/v of the final composition volume. In some versions, the water sub-volume has a volume of up to about 5% v/v, up to about 10% v/v, up to about 15% v/v, up to about 20% v/v, up to about 25% v/v, up to about 30% v/v, up to about 35% v/v, up to about 40% v/v, up to about 45% v/v, up to about 50% v/v, up to about 55% v/v, up to about 55% v/v, up to about 60% v/v, up to about 75% v/v, up to about 80% v/v, up to about 90% v/v, up to about 95% v/v, or up to about 99% v/v of the final composition volume. The HP-β-CD can be added to the water sub-volume in a weight amount sufficient to provide any of the concentrations described above for the composition of the invention when the composition is brought to final composition volume. The HP-β-CD-water mixture can be incubated for at least about 30 seconds, at least about 1 minute, at least about 2 minutes, at least about 3 minutes, at least about 4 minutes, at least about 5 minutes, at least about 10 minutes, or at least about 15 minutes. The oil or powder containing the astaxanthin in the oil mixture can be added to the mixture of HP-β-CD and water in an amount by weight sufficient to provide any of the concentrations described above for the composition of the invention when the composition is lead to the final composition volume.

Some versions also include pasteurization of the full volume oil-in-water emulsion. An exemplary method of pasteurization is tunnel pasteurization. The functional antioxidant suspension compositions described herein are contemplated to provide a functional benefit to a consumer (a “functional beverage” and/or a “functional supplement”). This functional nutritional supplement is formulated to provide an important source of antioxidants that contribute to the prevention, management and/or treatment of chronic diseases and/or maintenance of a healthy state.

Applications for use of the antioxidant nutritional supplement as described herein include, but are not limited to, prevention, management, and/or treatment of unhealthy blood glucose levels, intestinal health, immune system and neurological conditions. Moreover, the use of functional nutritional supplements as described herein may be for the maintenance of healthy conditions related to intestinal/digestive health, blood glucose levels, immune system response, and neurological/emotional conditions. The compositions of the invention may also or alternatively be used to reduce inflammation in any of several disease states, including inflammatory bowel disease and diabetes.

The compositions of the invention can be used for the treatment of a wide range of intestinal health applications. These applications include the general maintenance of intestinal health and the prevention of disorders. Additional uses of the compositions of the invention include increased antioxidant activity, an anti-inflammatory composition, improved glucose uptake/decreased insulin resistance, nephroprotective activity, improved memory, loss of weight and anticancer activity. Therefore, the present invention provides preventive and/or therapeutic compositions for the treatment of diseases and conditions or the maintenance of individuals' health when related to intestinal health.

The compositions provided herein can be used as preventive and/or therapeutic compositions for the treatment of diseases and conditions or the maintenance of individuals' health related to blood sugar level control. The compositions described herein may increase the effective delivered concentration of such useful functional ingredients that aid in the control or maintenance of blood glucose level, and may be formulated as a daily dietary supplement, preventive treatment, or clinical applications for treating conditions and systemic or chronic disease disorders. The compositions provided herein can also be used as preventive and/or therapeutic compositions for the treatment of diseases and conditions or the maintenance of mental, emotional and/or neurological health of individuals. The compositions provided herein increase the effective concentration of such useful functional ingredients as antioxidants from the xanthophyll group, which aid in the control or maintenance of mental, emotional, and/or neurological health, and can be formulated as a daily dietary supplement, preventive treatment or for clinical applications for treating systemic or chronic disease states and disorders.

A key aspect of many disease states is related to the individual's immune response. The immune system functions are multivariate processes that involve the systemic action of various cellular components and signals. In the optimal functional application of the compositions presented herein the effect of the antioxidant suspension enhances the natural activity level of the immune system and/or will act to prevent or attenuate adverse side effects associated with immune and/or inflammatory responses. The immune response is the body's defense mechanism against foreign substances that invade to cause infection and/or disease. Compromised immune systems or autoimmune responses can affect multiple aspects of health, including intestinal health, infectious disease states, cardiovascular health, mental/emotional health, etc. Immune system functions are complicated processes that involve the coordinated efforts of various cell types and cellular proteins, including, but not limited to, white blood cells, B-cells, T-cells (a subpopulation of white blood cells), cytokine interleukin-1 and -2 and necrosis factor. The antioxidant suspension described herein can be used as a preventive approach to enhance the immune response against oxidative stress. The antioxidant suspension described is effective against or providing support for a number of immune-related conditions. As exemplified below, the combined effect of astaxanthin and fucoxanthin may have a synergistic effect on the immune response. The functional composition described herein increases the effective concentration of antioxidants that help in the control or maintenance of immune health and function, and can be formulated as a daily nutritional supplement, preventive treatment or for clinical uses for treating systemic or chronic disease conditions and disorders. A particular aspect of the invention was directed to methods of decreasing inflammation in consumers. The methods comprise administering a composition comprising astaxanthin and fucoxanthin in amounts effective to decrease inflammation in the consumer. In some versions, the composition comprises astaxanthin and fucoxanthin in synergistically effective amounts to decrease inflammation. In some versions, the individual is an individual suffering from an inflammatory disorder. In some versions, the subject is a subject suffering from a condition selected from the group consisting of irritable bowel disease and diabetes. The invention also provides methods for maintaining or improving digestive health.

The methods comprise administering an antioxidant suspension of the invention to an individual in need thereof.

The invention also provides methods for enhancing the immune response in a subject. The methods comprise administering to the subject the antioxidant suspension of the invention. Enhancement of the immune response may further comprise lowering the severity of at least one of the group consisting of diarrhea, inflammatory bowel disease, Crohn's disease, ulcerative colitis, excessive stomach acid, dyspepsia, and pathogenic infection. The invention also provides methods for increasing glucose tolerance, increasing insulin sensitivity, and/or ameliorating obesity-induced inflammation in a mammal.

The w/v percentage refers to an amount of a substance in g/100 mL. The elements and method steps described herein can be used in any combination, whether explicitly described or not. All combinations of method steps as used in this document may be performed in any order, unless otherwise specified or otherwise clearly implied by the context in which the referenced combination is performed. Numerical ranges as used herein are intended to include every number and subset of numbers contained within that range, whether or not specifically disclosed.

Furthermore, these numerical ranges should be interpreted as providing support for a claim directed to any number or subset of numbers in that range. For example, a disclosure of 1 to 10 should be interpreted as supporting a range of 2 to 8, 3 to 7, 5 to 6, 1 to 9, 3.6 to 4.6, 3.5 to 9.9, etc. It is understood that the invention is not limited to the particular layout and arrangement of the parts illustrated and described herein, but rather includes modified forms thereof that fall within the scope of the claims.

### EXAMPLES

Method for Preparing the Antioxidant Suspension Described

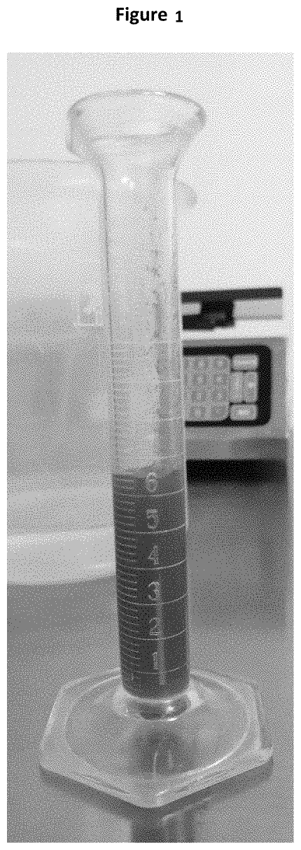

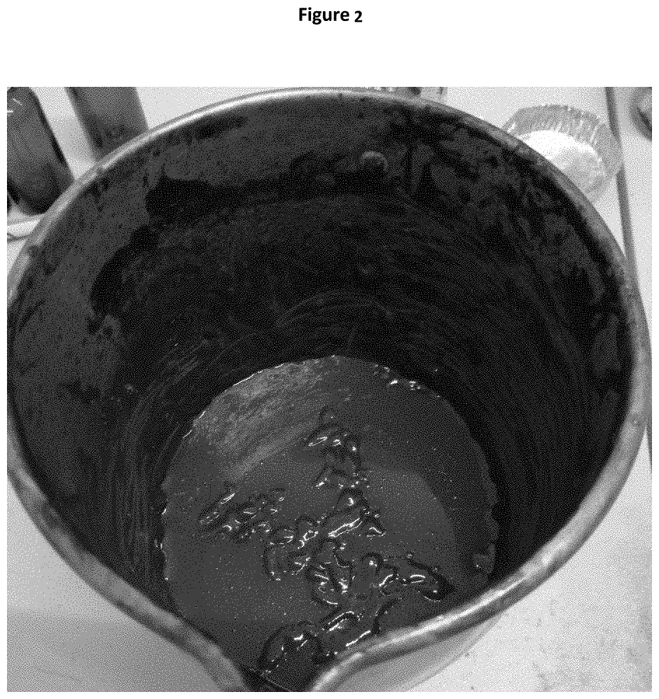

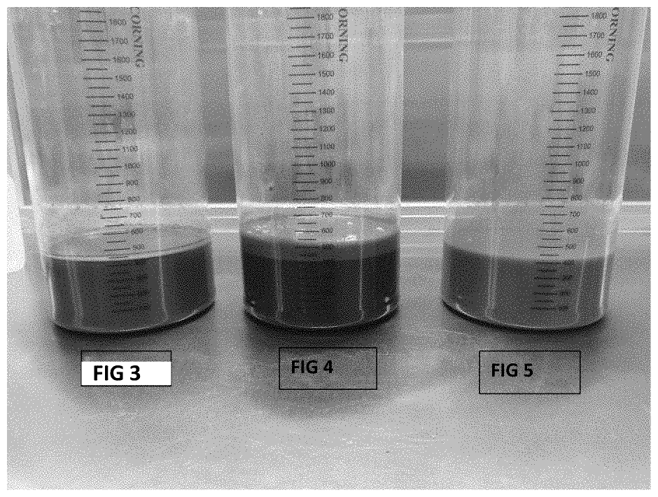

Astaxanthin is a non-polar compound not mixing completely with polar compounds to form a stable solution, even under vigorous mixing. Over time, the nonpolar compounds will aggregate together and fall out of aqueous suspension. FIG. 1 shows the result of water and oleoresin astaxanthin after being vigorously mixed. The resulting layer of pomegranate seed oil can be identified on the water surface. FIG. 2 shows a small amount of astaxanthin temporarily remaining in suspension after mixing, causing a light red color in the solution. FIG. 3 shows the result of fucoxanthin and water after being vigorously mixed wherein a thick suspension is generated in the water causing an intense orange color. FIG. 4 shows the homogenization of the suspension after mixing with HP-β-DC, without any visible suspension being detectable. The antioxidant suspension prepared only with polar and non-polar substances would behave and give rise to an immiscible and undesirable composition. In most cases, the non-polar components are likely to stick to the container sides.

For the success of the product, an adequate flavor and palatability are required, as well as a simple and safe preparation process. Immiscible components can result in material floating on the surface of the suspension, where immiscible materials can harbor and promote the growth of contaminating organisms. FIG. 5 shows the successful dissolution of astaxanthin and fucoxanthin, even at refrigeration temperatures.

Emulsions may be either complete or incomplete: a complete emulsion is one wherein the nonpolar and polar phases combine uniformly and permanently; an incomplete emulsion is one that is likely, over time, to settle out of their respective immiscible portions. Complete emulsions are typically achieved using an emulsifying agent or compound. Such a compound may exhibit polar and nonpolar distal moieties that will bind, respectively, to a nonpolar substance at one end of a molecule and a polar substance at the distal end of the molecule, allowing polar and nonpolar substances to be miscible. An incomplete emulsion can result from shaking, stirring, or agitating a solution, breaking a liquid substance into successively smaller droplets, and suspending the now tiny droplets of that substance within each other. As an example, the intense orange color shown in FIG. 5 is the result of the correct emulsification of the components at nanometric level to obtain a stable suspension over time.

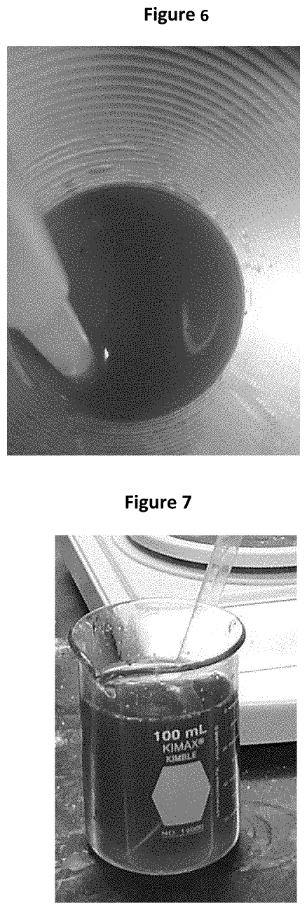

By adding a small amount of a flavor and citric acid, the effectiveness of miscibility is increased in the resulting suspension solution. FIG. 6 shows the effect of adding citric acid and flavor. The result was a homogeneous and stable emulsion. No layer of oil is visible on the surface.

HP-β-CD is the emulsifying agent that provides the best results in the suspension homogenization as shown in FIG. 7 which shows the product with and without HP-β-CD. This “hydrating” process allowed the astaxanthin and fucoxanthin to expand and dissolve more easily in water.

The astaxanthins used in the present examples (Astazine BGG World and Astareal Fuji Inc) are intense red oil-based, water-dispersible powders (equal to greater than or equal to 1% w/). Fucoxanthin is a water dispersible powder (BGG WORLD). Various compositions were generated using the components and methods described above. The following suspensions were each made in a total volume of 100 liters.

The antioxidant suspension was made by mixing the HP-β-CD and water and incubating the mixture for several minutes, mixing the astaxanthin, fucoxanthin, and then sequentially adding and mixing the remaining ingredients in the order listed. The resulting composition is a stable suspension with little or no residual unsuspended oil. The composition had a titratable acidity of 0.07 w/w.

### REFERENCES

Ambati R R, Moi P S, Ravi S, and Aswathanarayana R G. Astaxanthin: Sources, Extraction, Stability, Biological Activities and Its Commercial Applications—A Review. Sea Drugs. 2014; 12(1):128-52. doi: 10.3390/md12010128.
Capelli B, Bagchi D, and Cysewski G R. Synthetic astaxanthin is significantly inferior to algal-based astaxanthin as an antioxidant and may not be suitable as a human nutraceutical supplement. Nutrafoods. 2013; 12:145-152
Choi, H D, Youn, Y K and Shin, W G. Positive Effects of Astaxanthin on Lipid Profiles and Oxidative Stress in Overweight Subjects. Plant Foods Hum Nutr. 2011; 66; 363-369. doi: https://doi.org/10.1007/s11130-011-0258-9
Davinelli S, Nielsen M E, and Scapagnini G. Astaxanthin in Skin Health, Repair, and Disease: A Comprehensive Review. Nutrients. 2018; 10(4):522. doi:10.3390/nu10040522
Fassett R G, and Coombes J S. Astaxanthin: a potential therapeutic agent in cardiovascular disease. Mar Drugs. 2011; 9(3):447-465. doi:10.3390/md9030447
Giannaccare G, Pellegrini M, Senni C, Bernabei F, Scorcia V, and Cicero A F G. Clinical Applications of Astaxanthin in the Treatment of Ocular Diseases: Emerging Insights. Mar. Drugs. 2020; 18(5):239. doi:10.3390/md18050239
Grimmig B, Kim S H, Nash K, Bickford P C, and Douglas Shytle R. Neuroprotective mechanisms of astaxanthin: a potential therapeutic role in preserving cognitive function in age and neurodegeneration. Geroscience. 2017; 39(1):19-32. doi:10.1007/s11357-017-9958-x
Guerin M, Huntley M E, Olaizola M. Haematococcus astaxanthin: applications for human health and nutrition. Trends Biotechnol. 2003; 21(5):210-6. doi: 10.1016/S0167-7799(03)00078-7
Higuera-Ciapara I, Felix-Valenzuela L, and Goycoolea F M. Astaxanthin: a review of its chemistry and applications. Crit Rev Food Sci Nutr. 2006; 46(2):185-196. doi:10.1080/10408690590957188.
Katagiri M, Satoh A, Tsuji S, and Shirasawa T. Effects of astaxanthin-rich Haematococcus pluvialis extract on cognitive function: a randomized, double-blind, placebo-controlled study. J Clin Biochem Nutr. 2012; 51(2):102-107. doi:10.3164/jcbn.D-11-00017
Li X, Wang X, Duan C, et al. Biotechnological production of astaxanthin from the Haematococcus pluvialis microalgae. Biotechnol Adv. 2020; 43:107602. doi: 10.1016/j.biotechadv.2020.107602
Lyons N M, and O'Brien N M. Modulatory effects of an algal extract containing astaxanthin on UVA-irradiated cells in culture. J Dermatol Sci. 2002; 30(1):73-84. doi: 10.1016/s0923-1811(02)00063-4
Park J S, Chyun J H, Kim Y K, Line L L, and Chew B P. Astaxanthin decreased oxidative stress and inflammation and enhanced immune response in humans. Nutr Metab (Lond). 2010; 7:18. doi: 10.1186/1743-7075-7-18
Piermarocchi S, Saviano S, Parisi V, et al. Carotenoids in Age-related Maculopathy Italian Study (CARMIS): two-year results of a randomized study. Eur J Ophthalmol. 2012; 22(2):216-25. doi: 10.5301/ejo.5000069
Shah M M, Liang Y, Cheng J J, and Daroch M. Astaxanthin-Producing Green Microalga Haematococcus pluvialis: From Single Cell to High Value Commercial Products. Front Plant Sci. 2016; 7:531. doi: 10.3389/fpls.2016.00531
Su F, Yu W, and Liu J. Comparison of effect of dietary supplementation with Haematococcus pluvialis powder and synthetic astaxanthin on carotenoid composition, concentration, esterification degree and astaxanthin isomers in ovaries, hepatopancreas, carapace, epithelium of adult female Chinese mitten crab (Eriocheir sinensis). Aquaculture. 2020; 523. doi: 10.1016/j.aquaculture.2017.03.010
Sztretye M, Dienes B, Gönczi M, et al. Astaxanthin: A Potential Mitochondrial Targeted Antioxidant Treatment in Diseases and with Aging. Oxid Med Cell Longev. 2019. doi:10.1155/2019/3849692
Talbott S, Hantla D, Capelli B, et al. Astaxanthin Supplementation Reduces Depression and Fatigue in Healthy Subjects. EC Nutrition. 2019; 14(3):239-246.
Talukdar J, Bhadra B, Dattaroy T, Nagle V, and Dasgupta S. Potential of natural astaxanthin in alleviating the risk of cytokine storm in COVID-19. Biomed Pharmacother. 2020; 132:110886. doi: 10.1016/j.biopha.2020.110886
Tominaga K, Hongo N, Fujishita M, Takahashi Y, and Adachi Y. Protective effects of astaxanthin on skin deterioration. J Clin Biochem Nutr. 2017; 61(1):33-39. doi: 10.3164/jcbn.17-35.
Uttara B, Singh A V, Zamboni P, and Mahajan R T. Oxidative stress and neurodegenerative diseases: a review of upstream and downstream antioxidant therapeutic options. Curr Neuropharmacol. 2009; 7(1):65-74. doi:10.2174/157015909787602823
Yamashita E. Astaxanthin as a medical food. Funct Foods Health Dis. 2013; 3(7):254-258. doi:10.31989/ffhd.v3i7.49
Young A J, and Lowe G L. Carotenoids-Antioxidant Properties. Antioxidants (Basel). 2018; 7(2):28. doi:10.3390/antiox7020028
Yoshida H, Yanai H, Ito K, Tomono Y, Koikeda T, Tsukahara H, Tada N. Administration of natural astaxanthin increases serum HDL-cholesterol and adiponectin in subjects with mild hyperlipidemia. Atherosclerosis. 2010; 209(2):520-3. doi: 10.1016/j.atherosclerosis.2009.10.012
Yuan J P, Peng J, Yin K, and Wang J H. Potential health promoting effects of astaxanthin: A high-value carotenoid mostly from microalgae. Mol Nutr Food Res. 2011; 55:150-165. doi: 10.1002/mnfr.201000414.
Billakanti, J. M., Catchpole, O. J., Fenton, T. A., Mitchell, K. A., & Mackenzie, A. D. (2013). Enzyme-assisted extraction of fucoxanthin and lipids containing polyunsaturated fatty acids from Undaria pinnatifida using dimethyl ether and ethanol. Process Biochemistry, 48(12), 1999-2008. https://doi.org/10.1016/j.procbio.2013.09.015
Chuyen, H. Van, & Eun, J. (2017). Marine carotenoids: Bioactivities and potential benefits to human health. Critical Reviews in Food Science and Nutrition, 57(12):2600-2610. https://doi.org/10.1080/10408398.2015.1063477
D'Orazio, N., Gemello, E., Gammone, M. A., De Girolamo, M., Ficoneri, C., & Riccioni, G. (2012). Fucoxanthin: A treasure from the sea. Marine Drugs. https://doi.org/10.3390/md10030604
Dawczynski, C., Schubert, R., & Jahreis, G. (2007). Amino acids, fatty acids, and dietary fiber in edible seaweed products. Food Chemistry. https://doi.org/10.1016/493 Iberoam Forum. Rec. Mar. Acui. 9 (2020):485-497
Efecto neuroprotector de fucoxantina j.foodchem.2006.09.041 European Bioinformatics Institute. (2019). fucoxanthin (CHEBI:5186).
Ghannam, N. A., & Shannon, E. (2018). Seaweed Carotenoid, Fucoxanthin, as Functional Food. In V. K. Gupta, H. Treichel, V. (Olga) Shapaval, L. A. de Oliveira, & M. G. Tuohy (Eds.), Microbial Functional Foods and Nutraceuticals (First Edit, pp. 39-64). John Wiley & Sons Ltd.
Hashimoto, T., Ozaki, Y., Taminato, M., Das, S. K., Mizuno, M., Yoshimura, K., . . . Kanazawa, K. (2009). The distribution and accumulation of fucoxanthin and its metabolites after oral administration in mice. British Journal of Nutrition. https://doi.org/10.1017/S0007114508199007
Heo, Soo-Jin; Ko, Seok-Chun; Kang, Sung-Myung; Kang, Hahk-Soo; Kim, Jong-Pyung; Kim, Soo-Hyun; Lee, Ki-Wan; Cho, Man-Gi; Jeon, Y.-J. (2008). Cytoprotective effect of fucoxanthin isolated from brown algae Sargassum siliquastrum against H2O2-induced cell damage. European Food Research and Technology, 228(1): 145-151. https://doi.org/10.1007/s00217-008-0918-7
Heo, S. J., Ko, S. C., Kang, S. M., Kang, H. S., Kim, J. P., Kim, S. H., . . . Jeon, Y. J. (2008). Cytoprotective effect of fucoxanthin isolated from brown algae Sargassum siliquastrum against H2O2-induced cell damage. European Food Research and Technology. https://doi.org/10.1007/s00217-008-0918-7
Heo, S., Yoon, W., Kim, K., Ahn, G., Kang, S., Kang, D., Jeon, Y. (2010). Evaluation of anti-inflammatory effect of fucoxanthin isolated from brown algae in lipopolysaccharide-stimulated RAW 264. 7 macrophages. Food and Chemical Toxicology, 48(8-9):2045-2051. https://doi.org/10.1016/j.fct.2010.05.003
Hu, L., Chen, W., Tian, F., Yuan, C., Wang, H., & Yue, H. (2018). Neuroprotective role of fucoxanthin against cerebral ischemic/reperfusion injury through activation of Nrf2/HO-1 signaling. Biomedicine and Pharmacotherapy, 106(1):1484-1489. https://doi.org/10.1016/j.biopha.2018.07.088
Kajikawa, T., Okumura, S., Iwashita, T., Kosumi, D., Hashimoto, H., & Katsumura, S. (2012). Stereocontrolled total synthesis of fucoxanthin and its polyene chain-modified derivative. Organic Letters. https://doi.org/10.1021/ol203344c
Khodosevich, K., & Monyer, H. (2010). Signaling involved in neurite outgrowth of postnatally born subventricular zone neurons in vitro. BMC Neuroscience. https://doi.org/10.1186/1471-2202-11-18
Kim K, Ahn G, Heo S, Kang S, Kang M, Yang H, Jeon Y (2012). Inhibition of tumor growth in vitro and in vivo by fucoxanthin against melanoma B16F10 cells. Environmental 494 Toxicology and Pharmacology, 35(1), 39-46. https://doi.org/10.1016/j.etap.2012.10.002
Kim, S. M., Shang, Y. F., & Um, B. H. (2011). A preparative method for isolation of fucoxanthin from Eisenia bicyclis by centrifugal partition chromatography. Phytochemical Analysis. https://doi.org/10.1002/pca.1283
Kumar, S. R., Hosokawa, M., & Miyashita, K. (2013). Fucoxanthin: A Marine Carotenoid Exerting Anti-Cancer Effects by Affecting Multiple Mechanisms. Marine Drugs, 5130-5147. https://doi.org/10.3390/md11125130
Liu, C., Liang, A., & Hu, M. (2011). Protective effects of fucoxanthin against ferric nitrilotriacetate-induced oxidative stress in murine hepatic BNL CL. 2 cells. Toxicology in Vitro, 25(7), 1314-1319. https://doi.org/10.1016/j.tiv.2011.04.023
Maoka, T., Fujiwara, Y., Hashimoto, K., & Akimoto, N. (2007). Characterization of fucoxanthin and fucoxanthinol esters in the Chinese surf clam, mactra chinensis. Journal of Agricultural and Food Chemistry. https://doi.org/10.1021/jf063139n
Mikami, K., & Hosokawa, M. (2013). Biosynthetic pathway and health benefits of fucoxanthin, an algae-specific xanthophyll in brown seaweeds. International Journal of Molecular Sciences. https://doi.org/10.3390/ijms140713763
Miyashita, K., Nishikawa, S., Beppu, F., Tsukui, T., Abe, M., & Hosokawa, M. (2011). The allenic carotenoid fucoxanthin, a novel marine nutraceutical from brown seaweeds. Journal of the Science of Food and Agriculture, 91(7), 1166-1174. https://doi.org/10.1002/jsfa.4353
Muradian, K., Vaiserman, A., Min, K. J., & Fraifeld, V. E. (2015). Fucoxanthin and lipid metabolism: A minireview. Nutrition, Metabolism and Cardiovascular Diseases, 25(10), 891-897. https://doi.org/10.1016/j.numecd.2015.05.010
Neumann, U., Derwenskus, F., Flister, V. F., Schmid-staiger, U., Hirth, T., & Bischo, S. C. (2019). Fucoxanthin, A Carotenoid Derived from Phaeodactylum tricornutum Exerts Antiproliferative and Antioxidant Activities In Vitro. Antioxidants, 8(6):183.
Okuzumi, J., Nishino, H., Murakoshi, M., Iwashima, A., Tanaka, Y., Yamane, T., . . . Takahashi, T. (1990). Inhibitory effects of fucoxanthin, a natural carotenoid, on N-myc expression and cell cycle progression in human malignant tumor cells. Cancer Letters. https://doi.org/10.1016/0304-3835(90)90068-9
Pangestuti, R., & Kim, S. K. (2011). Biological activities and health benefit effects of natural pigments derived from marine algae. Journal of Functional Foods, 3(4):255-266. https://doi.org/10.1016/j.jff.2011.07.001
Sachindra, N. M., Sato, E., Maeda, H., Hosokawa, M., Niwano, Y., Kohno, M., & Miyashita, K. (2007). Radical scavenging and singlet oxygen quenching activity of marine carotenoid fucoxanthin and its metabolites. Journal of Agricultural and Food Chemistry. https://doi.org/10.1021/jf071848a
Saet, B. L., Joo, Y. L., Song, D. G., Pan, C. H., Chu, W. N., Min, C. K., Byung, H. U. (2008). Cancer chemopreventive effects of Korean seaweed extracts. Food Science and Biotechnology.
Sangeetha, R. K., Bhaskar, N., Divakar, S., & Baskaran, V. (2010). Bioavailability and metabolism of fucoxanthin in rats: Structural characterization of metabolites by LC-MS (APCI). Molecular and Cellular Biochemistry. https://doi.org/10.1007/s11010-009-0231-1
Satomi, Y. (2017). Antitumor and Cancer-preventive Function of Fucoxanthin: A Marine Carotenoid. 1562:1557-1562. https://doi.org/10.21873/anticancers.11484
Sugawara, T., Baskaran, V., Tsuzuki, W., & Nagao, A. (2002). Brown Algae Fucoxanthin Is Hydrolyzed to Fucoxanthinol during Absorption by Caco-2 Human Intestinal Cells and Mice. The Journal of Nutrition. https://doi.org/10.1093/jn/132.5.946
Sun, P., Wong, C. C., Li, Y., He, Y., Mao, X., Wu, T., . . . Chen, F. (2019). A novel strategy for isolation and purification of fucoxanthinol and fucoxanthin from the diatom Nitzschia laevis. Food Chemistry, 277 (November, 2018):566-572. https://doi.org/10.1016/j.foodchem. 2018.10.133
Wang, L., Park, Y. J., Jeon, Y. J., & Ryu, B. M. (2018). Bioactivities of the edible brown seaweed, Undaria pinnatifida: A review. Aquaculture, 495 (May):873-880. https://doi.org/10.1016/j.aquaculture.2018.06.079
Wang, X., Cui, Y., Qi, J., Zhu, M., Zhang, T., Cheng, M., & Liu, S. (2018). Fucoxanthin Extracts Cytoprotective Effects against Hydrogen Peroxide-induced Oxidative Damage in L02 Cells. BioMed Research International, 1-25. https://doi.org/10.1155/2018/1085073
Willstatter, R., & Page, H. (1914). Chlorophyll. XXIV. The pigments of the brown algae. Justus Liebig's Annalen Der Chemie, 3(404):237-271.
Zhang, H., Tang, Y., Zhang, Y., Zhang, S., Qu, J., Wang, X., . . . Liu, Z. (2015). Fucoxanthin: A Promising Medicinal and Nutritional Ingredient. Evidence-Based Complementary and Alternative Medicine. https://doi.org/10.1155/2015/723515
Zhang, L., Wang, H., Fan, Y., Gao, Y., Li, X., Hu, Z., . . . Wang, X. (2017). Fucoxanthin provides neuroprotection in models of traumatic brain injury via the Nrf2-ARE and Nrf2-autophagy pathways. Scientific Reports, 7 (January), 1-15. https://doi.org/10.1038/srep46763

1. An emulsion consisting essentially of water, xanthophyll group carotenoids, and cyclodextrins (HP-β-CD OR HYDROXYPROPYL BETA CYCLODEXTRIN) which are stably suspended in water.

2. The emulsion of claim 1, wherein water is present in the emulsion in an amount of at least 95% w/v; a carotenoid from the group of xanthophylls is present in the emulsion in an amount of 0.001% w/v to 0.1% w/v; a second carotene is present in the emulsion in an amount of 0.001% w/v to 0.1% w/v; the cyclodextrin present in the emulsion in an amount of 0.0005% w/v to 0.05% w/v.

3. The emulsion of claim 1, wherein the emulsion has no more than 0.01% w/v of a combined total of sorbic acid.

4. The emulsion of claim 1, further consisting essentially of 0.05% w/v to 5% w/v citric acid.

5. The emulsion of claim 1, further consisting essentially of a component selected from the group formed by corn-derived cyclodextrins of the beta group.

6. The emulsion of claim 1, further consisting essentially of an antioxidant selected from the group of xanthophylls formed by lutein, astaxanthin and zeaxanthin and combinations thereof.

7. The emulsion of claim 1, further consisting essentially of a carotenoid derived from brown algae.

8. The emulsion of claim 1, further consisting of a flavor component from natural sources which is in a ratio between 1.0 and 0.001 p/v.

9. The emulsion of claim 1, further consisting of 1% w/v to 10% w/v of a naturally occurring low-calorie sugar listed as a food ingredient.
